(19) United States
(12) Patent Application Publication
(10) Pub. No.: US 2025/0035000 A1
(43) Pub. Date: Jan. 30, 2025

(54) TURBOMACHINE VANE PROVIDED WITH A COOLING CIRCUIT AND METHOD FOR LOST-WAX MANUFACTURING OF SUCH A VANE

(71) Applicant: SAFRAN, Paris (FR)

(72) Inventors: Sylvain PAQUIN, MOISSY-CRAMAYEL (FR); Adrien Bernard Vincent ROLLINGER, MOISSY-CRAMAYEL (FR); Romain Pierre CARIOU, MOISSY-CRAMAYEL (FR); Filippo PAGNONI, MOISSY-CRAMAYEL (FR)

(73) Assignee: SAFRAN, Paris (FR)

(21) Appl. No.: 18/574,784

(22) PCT Filed: Jun. 23, 2022
(86) PCT No.: PCT/FR2022/051227

§ 371 Date: Dec. 28, 2023

(30) Foreign Application Priority Data
Jul. 2, 2021 (FR) FR2107176

(51) Int. Cl. F01D 5/18

(52) U.S. Cl. CPC F01D 5/188; F05D 2230/21; F05D 2240/12; F05D 2260/2212

(57) ABSTRACT

A vane for an aircraft turbomachine includes a blade and a cooling circuit inside the blade. The cooling circuit has at least one longitudinal flow cavity of a cooling air stream (RF). The cooling circuit further includes elements that protrude into the cavity and are configured to disrupt the air stream. Each of the protruding elements is generally arc-shaped and internally defines, with a first wall, a first cross-sectional flow area, and externally, with a second wall opposite the first wall, a second cross-sectional flow area. Each of the elements is configured such that the first or second cross-sectional flow area is reduced from upstream to downstream relative to the direction of the air stream.

### FIELD OF THE INVENTION

The present invention relates to the field of the turbomachines and in particular to a turbomachine vane provided with a cooling circuit intended to cool it. It also covers a method for lost-wax manufacturing of such a vane.

### BACKGROUND

The technical background includes in particular the documents US-A1-2019/316472, US-A1-2019/112942 and CN-A-101 007 337.

The turbomachine vanes, in particular the high-pressure turbine vanes, are subjected to very high temperatures that can shorten their service life and degrade the performance of the turbomachine. The turbomachine turbines are arranged downstream of the combustion chamber of the turbomachine, which ejects a hot gas stream that is expanded by the turbines and allows them to be driven in rotation for the operation of the turbomachine. The high-pressure turbine, which is located directly at the outlet of the combustion chamber, is subject to the highest temperatures.

In order to allow the turbine vanes to withstand these severe thermal constraints, it is known to provide a cooling circuit in which relatively cooler air circulates, which is taken at the level of the compressors, the latter being located upstream of the combustion chamber. More specifically, each turbine vane comprises a blade with a pressure side wall and a suction side wall which are connected upstream by a leading edge and downstream by a trailing edge.

The cooling circuit generally comprises several cavities inside the blade of the vane, some of which communicate with each other and which are supplied with cooling air from the root of the vane, a part of this cooling air opening into outlet orifices located near the trailing edge. These orifices deliver cooling air jets to the walls of the blade.

It is known that the cooling circuit comprises several partitions extending radially in the blade so as to form “rising” and “falling” cavities arranged successively in the orientation of circulation of the cooling air and which communicate with each other via curved passages. These cavities and passages are known as “paper-clips” circuits.

The cavities of the cooling circuit are generally formed by at least one foundry core, which is used in a method for manufacturing the vane using the lost-wax foundry technique.

The cavities of the cooling circuit are often provided with turbulence promoters to increase heat exchange. A turbulence promoter is a projecting element in the cavity, the function of which is to generate disturbances and turbulence in the air stream circulating in the cavity, in order to increase heat exchange between this air stream and the walls of the cavity (see for example the document FR-A1-3 065 985).

The usual turbulence promoters are of various types but have historically been constrained by the demoulding capacity required for the cores used to form cavities and turbulence promoters.

Common shapes include simple, straight or inclined herringbone-shaped disruptors, simple protuberances or hollows of cylindrical or teardrop shape, or bridges that cross cavities and connect two opposite walls (typically the pressure side and suction side).

Depending on their type, spacing and geometric dimensions, these disruptors have different thermal efficiencies, but this efficiency remains proportional to the pressure losses generated: in a pressure losses/thermal efficiency diagram, all these geometries are essentially aligned. As the rate of excess pressure available to circulate the air in the circuit is limited, there is a strong case for increasing the heat exchange/pressure loss ratio.

The heat exchanges obtained are also not very homogeneous.

It is also difficult to increase heat exchange on one face (typically a hot wall), while limiting heat exchange on the opposite face (typically a cold internal partition), as this unnecessarily increases pressure losses and increases the temperature gradient between the cold internal partition and the hot external wall, which is detrimental to the mechanical strength of the vane.

There is therefore a need to define a technology that provides a solution to at least a part of these problems.

### SUMMARY OF THE INVENTION

The aim of the present invention is to improve the ratio of heat exchange on the hot walls to pressure losses in the cavity, by using a new configuration of turbulence promoters.

This objective is achieved in accordance with the invention by means of an aircraft turbomachine vane, this vane comprising a blade and a cooling circuit inside the blade, this cooling circuit comprising at least one longitudinal cavity for the flow of a cooling air stream, the cooling circuit further comprising projecting elements into said cavity and which are configured to disrupt said air stream, characterised in that each of said projecting elements has the general shape of an arch and comprises two lateral legs and a median roof, the legs extending between a first wall of the cavity and said roof, this roof interconnecting said legs, and in that each of said elements defines internally, with said first wall, a first passage cross-section, and externally, with a second wall opposite the first wall, a second passage cross-section, and each of said elements being configured so that said first or second passage cross-section is reduced from upstream to downstream with respect to the direction of said air stream.

The present invention thus proposes the use of arch-shaped projecting elements. These projecting elements have the particularity of allowing a reduction in the air passage cross-section either inside or outside them, so as to accelerate the air passing through this air passage cross-section. Increasing the flow speed of the air on the wall to which a projecting element is connected, or on the opposite wall, increases the heat exchange between the air and this wall and therefore optimises the cooling of the vane.

The principle of the invention is therefore to increase heat exchange by influencing flow speed of the air rather than the turbulences. In fact, the turbulences increase the pressure losses at the same time as heat exchange, whereas the acceleration increases heat exchange while refining the boundary layer and therefore reducing the pressure losses. In addition, the establishment of the turbulence requires several promoters before reaching an optimum level for increasing heat exchange, so it cannot be used for very local cooling.

The vane also comprises one or more of the following characteristics, taken alone or in combination:
the roof comprising a first face which faces the first wall, and a second face which faces the second wall, at least one of the first and second faces being inclined with respect to the facing wall, from upstream to downstream relative to the direction of said air stream, so as to reduce the corresponding passage cross-section;
said roof of each of said projecting elements is inclined with respect to said first and second walls
said first and second faces are substantially parallel to each other;
said projecting elements are arranged one behind the other inside said cavity and form a row of projecting elements extending along said direction of said air stream, the row comprising for example between 5 and 10 projecting elements;
said legs of each of said projecting elements are separated from each other by a distance representing more than 40% of a width of said cavity;
said legs of each of said projecting elements are oriented in a convergent manner from upstream to downstream;
said legs and said roof of each of said projecting elements comprise upstream edges which are convexly rounded;
said roof of each of said projecting elements is located substantially at half a height in said cavity, this height being measured between said first and second walls;
each of said projecting elements defines an internal air passage cross-section which has a generally rectangular, circular, oblong or trapezoidal shape;
the reduction in the passage cross-section from the inlet to the outlet of each of the projecting elements is of the order of at least 10%;
the passage cross-section inside and at the inlet of each of the projecting elements can represent at least 25% of the total passage cross-section of the cavity;
each of the projecting elements has a length noted L3 and has an inlet with a height noted h, the length L3 being between 0.5.h and 3.h.

The present invention also relates to a method for manufacturing lost-wax of a vane as described above, characterised in that it comprises the following steps:
providing a refractory ceramic or metallic core for forming said cavity, this core having an elongated shape and comprising internal U-shaped ducts which are configured to form said projecting elements by moulding, each of said ducts each comprising two ends which open onto a same face of the core configured to form said first wall by moulding,
injecting wax so as to coat the core and form a model,
manufacturing a shell enveloping the model,
pouring molten metal into the shell to form the vane, and
stripping the shell and core to release the vane and form the cooling circuit with its cavity and projecting elements.

The invention also relates to a turbomachine turbine comprising at least one turbomachine vane having the above-mentioned characteristics.

The invention also relates to a turbomachine comprising at least one turbomachine turbine as aforesaid.

### BRIEF DESCRIPTION OF THE FIGURES

The invention will be better understood, and other purposes, details, characteristics and advantages thereof will become clearer on reading the following detailed explanatory description of embodiments of the invention given by way of purely illustrative and non-limiting examples, with reference to the appended schematic drawings in which:

FIG. 1 is a schematic view in axial and partial cross-section of an example of a turbomachine to which the invention applies;

FIG. 2 is a schematic axial section view of a turbomachine vane with a cooling circuit according to the invention;

FIG. 3 is a schematic cross-sectional view of a blade of a turbomachine vane comprising a cooling circuit with various cavities;

FIG. 4 is a perspective view of projecting elements located in a cavity of a cooling circuit of a vane according to the invention;

FIGS. 5A and 5B are respectively schematic views of a projecting element, seen from above in a cavity, and seen in cross-section along line B-B in FIG. 5A;

FIGS. 5C and 5D are respectively schematic views of the projecting element, seen in cross-section along line C-C in FIG. 5A, seen in cross-section along line D-D in FIG. 5A;

FIG. 6A is a schematic cross-sectional view of a cavity of a cooling circuit of a vane according to the invention, the cross-sectional plane passing through legs of projecting elements located in this cavity, and FIG. 6B being a larger scale view of a detail of FIG. 6A;

FIG. 7A is a schematic cross-sectional view of a cavity of a cooling circuit of a vane according to the invention, the cross-sectional plane passing through roofs of projecting elements located in this cavity, and FIG. 7B being a larger-scale view of a detail of FIG. 7A;

FIG. 8 is a schematic view of a ceramic core for moulding the cavity of a vane according to the invention; and

FIG. 9 is a schematic cross-sectional view along line IX-IX of FIG. 8.

### DETAILED DESCRIPTION OF THE INVENTION

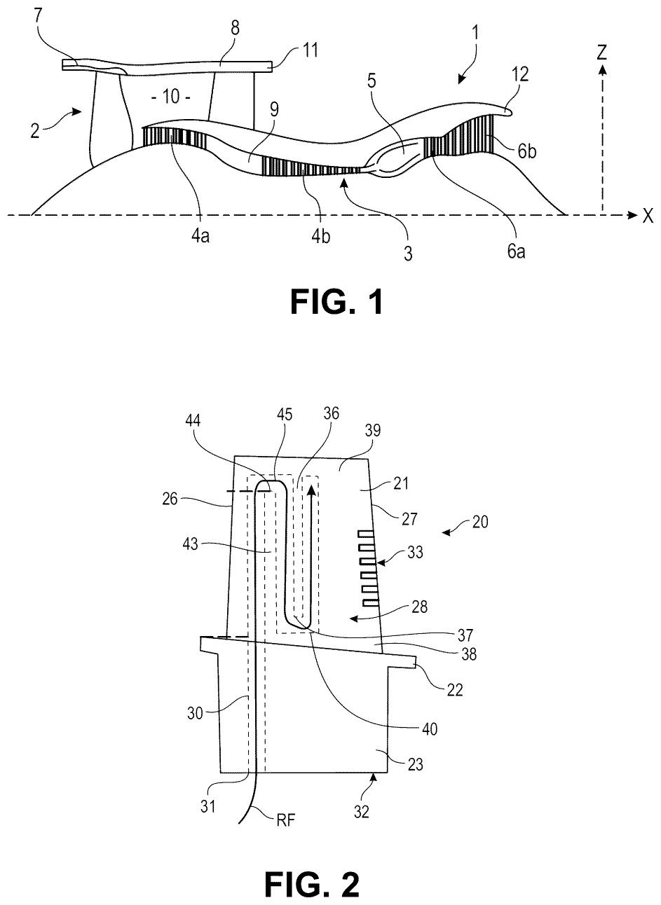

FIG. 1 shows a partial axial cross-section of a turbomachine 1 of longitudinal axis X to which the invention applies. The turbomachine shown is a double-flow and double-body turbomachine intended to be mounted on an aircraft according to the invention. Of course, the invention is not limited to this type of turbomachine.

This double-flow turbomachine 1 generally comprises a fan 2 mounted upstream of a gas generator 3. In the present invention, and in general, the terms “upstream” and “downstream” are defined with respect to the circulation of the gases in the turbomachine and here along the longitudinal axis X (and even from left to right in FIG. 1). The terms “axial” and “axially” are defined with respect to the longitudinal axis X. Similarly, the terms “radial”, “internal” and “external” are defined with respect to a radial axis Z perpendicular to the longitudinal axis X and with respect to the distance from the longitudinal axis X.

The gas generator 3 comprises, from upstream to downstream, a low-pressure compressor 4a, a high-pressure compressor 4b, a combustion chamber 5, a high-pressure turbine 6a and a low-pressure turbine 6b.

The fan 2, which is surrounded by a fan casing 7 carried by a nacelle 8, divides the air entering the turbomachine into a primary air stream which passes through the gas generator 3 and in particular in a primary vein 9, and into a secondary air stream which circulates around the gas generator in a secondary vein 10.

The secondary air stream is ejected by a secondary nozzle 11 terminating the nacelle while the primary air stream is ejected outside the turbomachine via an ejection nozzle 12 located downstream of the gas generator 3.

The high-pressure turbine 6a, like the low-pressure turbine 6b, comprises one or more stages. Each stage comprises a stator blading mounted upstream of a mobile blading. The stator blading comprises a plurality of stator or fixed vanes, referred to as distributor, which are distributed circumferentially about the longitudinal axis X. The mobile blading comprises a plurality of mobile vanes which are equally circumferentially distributed around a disc centred on the longitudinal axis X. The distributors deflect and accelerate the aerodynamic stream leaving the combustion chamber towards the mobile vanes so that the latter are driven in rotation.

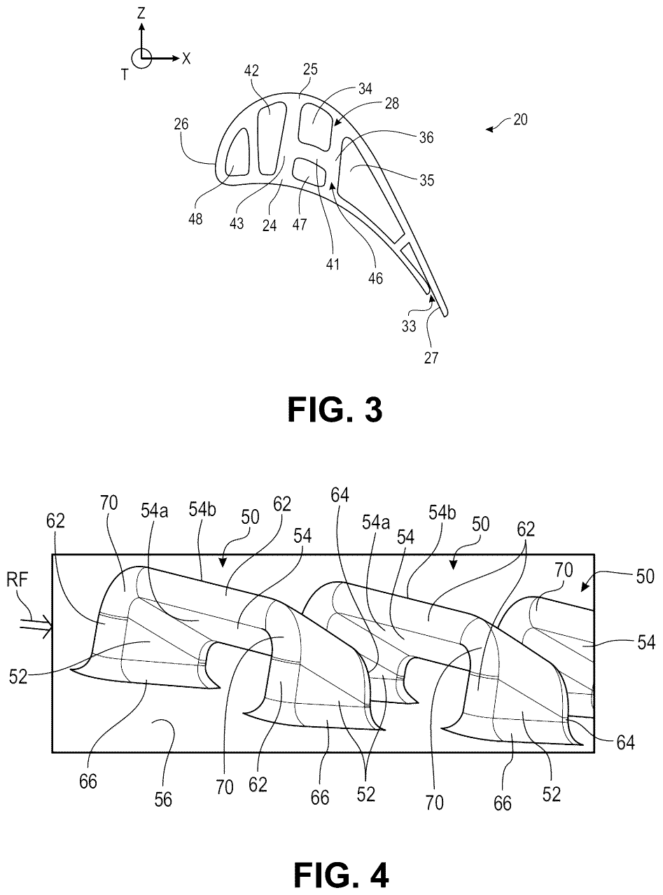

With reference to FIGS. 2 and 3, each turbine vane (and here a high-pressure turbine mobile vane 20) comprises a blade 21 rising radially from a platform 22. The latter is carried by a root 23 which is intended to be implanted in one of the corresponding grooves of the turbine disc. Each blade 21 comprises a pressure side wall 24 and a suction side wall 25 which are connected upstream by a leading edge 26 and downstream by a trailing edge 27. The pressure side 24 and suction side 25 walls are opposite each other along a transverse axis T which is perpendicular to the longitudinal axis X and radial axis Z.

The increased need for performance and the evolution in aeronautical regulations are driving today's engine manufacturers to design engines that operate in increasingly severe environments (temperature, pressure, rotational speed, emissions, etc.). This implies the need to define “new generation” high pressure turbine vanes that can withstand this type of stress.

Increasing the temperature of the gas driving the vane improves the yield of the turbomachine. This temperature is several hundred degrees higher than the melting point of the super-alloy used in the vane. The vane must therefore be cooled more and more efficiently.

To achieve this, the vane 20 comprises a cooling circuit 28 which is arranged inside the blade 21 and is designed to cool the walls of the blade subjected to the high temperatures of the primary air stream leaving the combustion chamber 5 and passing through it. This cooling circuit 28 comprises several cavities which communicate with each other to form a “paper clip” type duct. This latter includes several passages or turnarounds so that a cooling fluid, in this case cooling air, sweeps over the assembly of the blade and up and down along the radial axis.

The root 23 comprises a supply channel 30 which includes a cooling air inlet 31 taken from upstream of the combustion chamber 5, such as from the low-pressure compressor 4a, and which opens into the paper clip type duct. The channel 30 also opens onto a radially internal face 32 of the root of the vane, which includes the cooling air inlet 31. The cooling circuit 28 also includes outlet orifices 33 arranged in the vicinity of the trailing edge 27 of the blade. The outlet orifices 33 are oriented substantially along the longitudinal axis X and are aligned and evenly distributed substantially along the radial axis. In this way, the cooling air RF flowing from the root of the vane passes through the cavities inside the blade and opens into the outlet orifices 33.

As shown in detail in FIG. 3, the cooling circuit 28 comprises several cavities arranged successively from upstream to downstream of the blade 21. In particular, a first cavity 34 and a second cavity 35 each extend along the radial axis in the blade. The second cavity 35 is arranged downstream of the first cavity 34 in the orientation of circulation of the cooling air (and from upstream to downstream along the longitudinal axis X). The first cavity 34 and the second cavity 35 are separated, at least partly, by a first radial partition 36 which has a radially internal free end 37. This latter is located at the level of the root connection end 38 of the vane (radially opposite the free end 39 of the blade). The free end 39 of the blade also includes a closing wall (not shown) that allows cooling air to be contained inside the blade for cooling. The first partition 36 is connected to the closure wall at its radially external end (opposite its radially internal free end 37).

The cooling circuit 28 also includes a third cavity 42 which extends radially inside the blade. The third cavity 42 is located upstream of the first cavity 34 in the orientation of circulation of the cooling air RF. The third cavity 42 is separated at least partly from the first cavity 34 by a second radial partition 43 which comprises a radially external free end 44. The third cavity 42 and the first cavity 34 are connected by a second cooling fluid passage 45 which is bounded at least partly by the radially external free end 44. The closing wall also delimits the second passage 45.

The cavities 34, 35 and 42 arranged successively in the orientation of circulation of the cooling fluid form the paper clip type duct.

The blade 21 can include another cooling circuit 46 which also cools the blade. The cooling circuit 46 comprises a pressure side cavity 47 which extends radially inside the vane. The pressure side cavity 47 is used specifically to cool the pressure side wall and the upper part of the blade along the radial axis. The air injected into this cavity can leave the blade via the outlet orifices 33 or via other orifices located on the pressure side wall, for example. As can be seen in FIG. 3, the pressure side cavity 47 extends transversely between the internal wall 41 and the pressure side wall 24. It also extends longitudinally in the orientation of circulation of the air stream between the cavities 35, 42. In other words, the cavity 35 transversely covers the cavities 34 and 47. Its length is substantially the same as that of the first cavity 34 in the orientation of circulation of the cooling air (axial orientation).

Upstream of the third cavity 42 is an upstream cavity 48 of another cooling circuit for the blade 21, this cavity 48 extending radially along the leading edge 26.

It is clear from the above that a turbomachine vane may comprise one or more internal cooling circuits and that each of these circuits may comprise one or more cavities for circulating a cooling air stream.

Turbulence promoters are known to be provided in at least one of these cavities. These turbulence promoters are projecting elements on a wall of a circulation cavity of an air stream, the purpose of which is to generate disturbances and turbulence in the air stream in order to increase the heat exchanges between the air stream and the wall of the cavity.

The present invention proposes a new advantageous configuration of these projecting elements, which are in the form of arches 50, as can be seen in FIG. 4. Each arch 50 or projecting element comprises two lateral legs 52 and a median roof 54. The legs 52 extend between a first wall 56 of the cavity 58 and the roof 54, and this roof 54 extends between the legs 52 and connects them together.

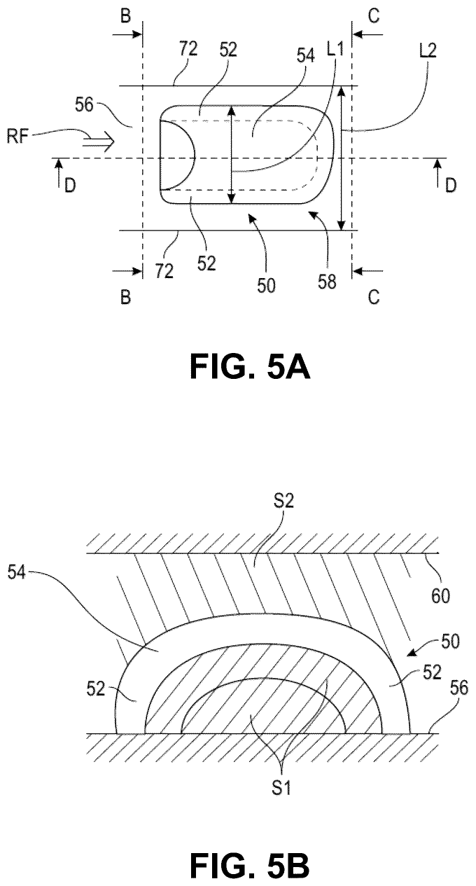

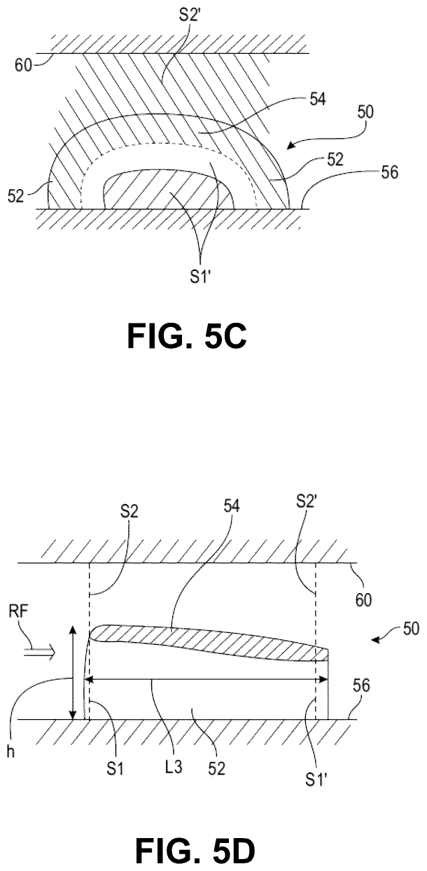

As can be seen in FIGS. 5A to 5D, each arch 50 defines on the inside, with the first wall 56 to which it is connected, a first passage cross-section S1-S1′, and on the outside, with a second wall 60 opposite the first wall 56, a second passage cross-section S2-S2′. The passage cross-section is denoted S1 inside and at the inlet or upstream of the arch S0, S1′ inside and at the outlet or downstream of the arch, S2 outside and at the level of the inlet of the arch, and S2′ outside and at the level of the outlet from the arch. Each arch 50 is configured so that the first or second passage cross-section S1-S1′, S2-S2′ is reduced from upstream to downstream with respect to the direction of the air stream (arrow RF). In other words, each arch 50 is configured so that the passage cross-section S1′ at the outlet of the arch is smaller than the passage cross-section S1 at the inlet of the arch, or so that the passage cross-section S2′ at the outlet of the arch is smaller than the passage cross-section S2 at the inlet of the arch. Each passage cross-section is generally rectangular, circular, oblong, trapezoidal, etc. in shape.

The reduction in the passage cross-section allows the speed of the air stream to be increased. Thus, when the passage cross-section is reduced inside the arch 50 and therefore on the side of the first wall 56, the air stream which flows over this first wall 56 is accelerated, which increases the heat exchange between this air stream and the wall 56.

When the passage cross-section is reduced outside the arch 50, on the side of the second wall 60, the air stream over this second wall is accelerated, which increases the heat exchange between this air stream and the wall 60.

The passage cross-section can be reduced by adjusting the dimensions of the arch 50, and in particular the width and/or height of the arch inlet and outlet, the length and thickness of the legs 52 and roof 54 of the arch 50, etc. The distance between two consecutive arches 50 can also allow the level of exchange to be modulated.

The roof 54 comprises a first face 54a which faces the first wall 56 from which the arch 50 or the element projects. The roof 54 comprises a second face 54b facing the second wall 60 and opposite the wall 54a.

Depending on the cooling requirements and manufacturing constraints, the arch 50 can therefore be positioned on the wall 56 located on the pressure side or suction side of the blade 21. The wall 56 is then cooled by adjusting the velocity, and the opposite wall 60 is also cooled but by optimising the vortices and therefore the turbulence in the air stream RF. Depending on the cooling requirements of the wall 60, the intensity of the vortices generated at the upper corners 70 of the arch 50 can be modulated, for example, by adjusting the slope of the arch 50 (difference in inlet/outlet height in relation to its length) or, more generally, the shape of its generator. In the figures, the axial cross-section of the arch 50 (FIG. 5D) is in the shape of a rectangle, the corners of which are radiused and the dimensions of which decrease linearly to form a convergent section, but this cross-section could be in the shape of an arc of a circle, an ellipse, a sinusoid or any other shape depending on the type of flow desired on the wall 60. The inlet and outlet cross-sections S1, S1′, S2, S2′ can thus vary, as mentioned above, and convergence can be non-linear, in order to minimise the pressure losses for example.

Alternatively, the arch 50 can be configured to accelerate the air stream at the level of the wall 60 and not at the wall 56. In this case, the arch 50 still forms a convergent point in the orientation of the flow, but on the side of this wall 60.

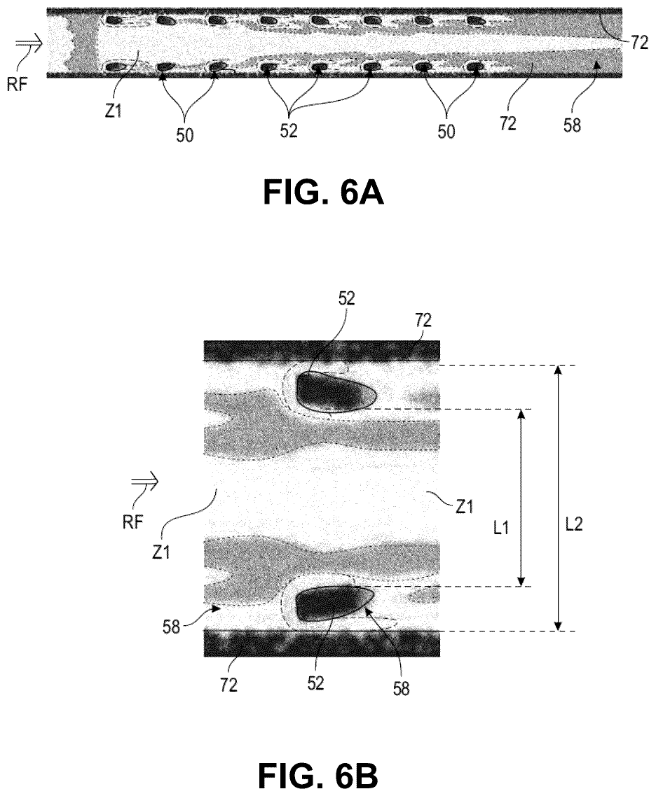

According to the embodiment of the invention illustrated in FIG. 4 and FIGS. 6A to 6D, at least one of the faces 54a, 54b is inclined with respect to the opposite wall 56, 60, from upstream to downstream with respect to the direction of the air stream RF, so as to reduce the corresponding passage cross-section S1-S1′, S2-S2′.

The inclination of one of the faces 54a, 54b or of both faces of the roof 54 can be obtained by an inclination of the roof 54, a variation in the thickness of the roof, or a combination of the two.

In the example shown, the faces 54a, 54b are substantially parallel to each other. The face 54a is inclined from upstream to downstream towards the wall 56 and therefore reduces the first passage cross-section S1-S1′ inside the arch 50, between the inlet and outlet of the arch, resulting in an acceleration of the air stream on the wall 56.

The legs 52 and the roof 54 of each arch 50 comprise upstream edges 62 which are convexly rounded in the example shown in FIG. 4. The legs 52 may also comprise downstream edges 64 which are convexly rounded. The ends of the legs 52, opposite the roof 54, can be connected to the wall 56 by fillets 66. The legs 52 are connected to the roof 54 by the corners 70, which are curved and have no sharp ridges. Taken together, these characteristics improve the aerodynamics of the arch 50 so that it can perform its function of accelerating the air stream passing inside the arch while generating as little disturbance as possible in this air stream.

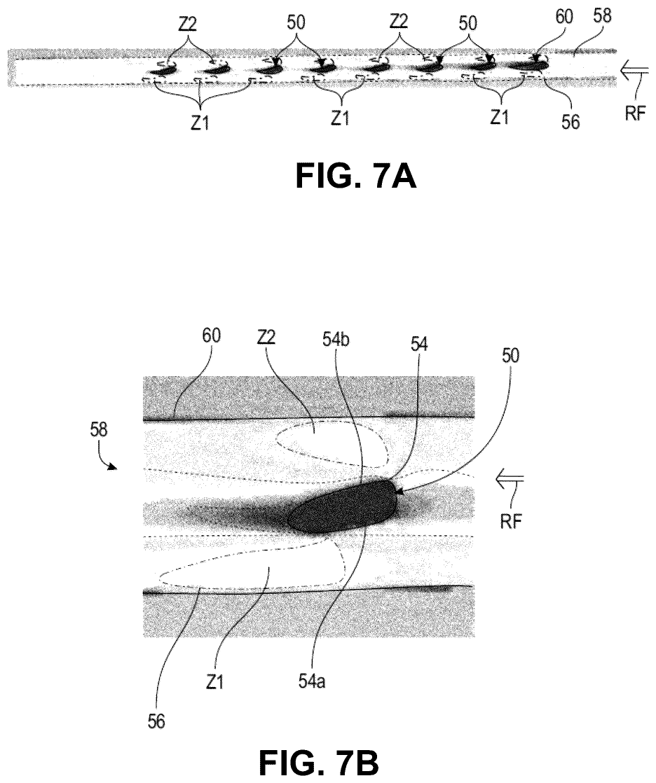

The arches 50 are preferably arranged one behind the other inside the cavity 58 and form a row of arches. Each row comprises, for example, between 5 and 10 projecting elements, as illustrated in FIGS. 6A and 7A.

FIGS. 6A and 6B show that the legs 52 can also be inclined with respect to each other and with respect to the lateral walls 72 of the cavity 58. For example, the legs 52 converge towards each other from upstream to downstream so as to accentuate the reduction in the passage cross-section.

The legs 52 are located in the immediate vicinity of the lateral walls 68 in the example shown. The legs 52 are separated from each other by a minimum distance L1 representing at least 40%, or even 60%, of a width L2 of the cavity 58.

FIGS. 7A and 7B show the inclination of the roofs 54 of the arches 50 of this embodiment. In the example shown, the roofs 54 are located approximately halfway up the cavity 58.

FIGS. 6A to 7B also show the zones Z1 of acceleration of the air stream inside the arches 50 and the overall acceleration of the air stream in the cavity 58 (arrow RF). It can also be seen that the equilibrium level of heat exchange is reached as early as the first arch 50. In addition, the exchange level is much more uniform across the width L2 of the cavity 58. The inventors found that with this geometry, the heat stream increased by 5.1%, while the pressure losses increased by only 2.7% with respect to the conventional turbulence promoters. The arches 50 generate controlled Z2 vortices that also cool the opposite wall 60 much more effectively than conventional promoters.

The reduction in the passage cross-section inside or outside the arch 50, as mentioned above, may be of the order of at least 10%. In the case, for example, where it is the internal passage cross-section S1-S1′ of the arch 50 that is reduced, this means that the ratio S1′/S1 is less than or equal to 0.9.

The passage cross-section inside and at the inlet of the arch 50 can represent at least 25% of the total passage cross-section of the cavity. In other words, the ratio S1/(S1+S2) is at least 0.25.

The arch has a length noted L3 and its inlet has a height noted h. Preferably, the length L3 is between 0.5.h and 3.h (see FIG. 5D).

These different parameters can be optimised as a function of the other dimensions of the cavity 58 and the arch 50 (thickness, etc.) in order to control the variation in the external section of the arch and therefore the vortices that may be created. Thus, if the wall 60 opposite that of the arch 50 does not require additional cooling, the aim will be to limit the expansion of the section outside the arch to less than 30% in order to limit delamination and therefore pressure losses. Conversely, if the cooling of the opposite wall needs to be improved, an upper expansion outside the arch may be of interest, as the convergence of the cross-section under the arch could then be increased (while avoiding too high an acceleration leading to Mach 1 in the cavity, for example, which would generate high pressure losses).

The thickness of the walls of the arch 50 must be as thin as possible while still allowing for manufacturability and ensuring the mechanical strength of the vane 20 during operation. Preferably, the material cross-section at the inlet to the arch 50 should not represent more than 40% of the total cross-section of the cavity.

Advantageously, but without limitation, the vane 20 is made from a metallic alloy using a manufacturing method based on the lost-wax foundry technique. The metallic alloy is preferably nickel-based and can be monocrystalline.

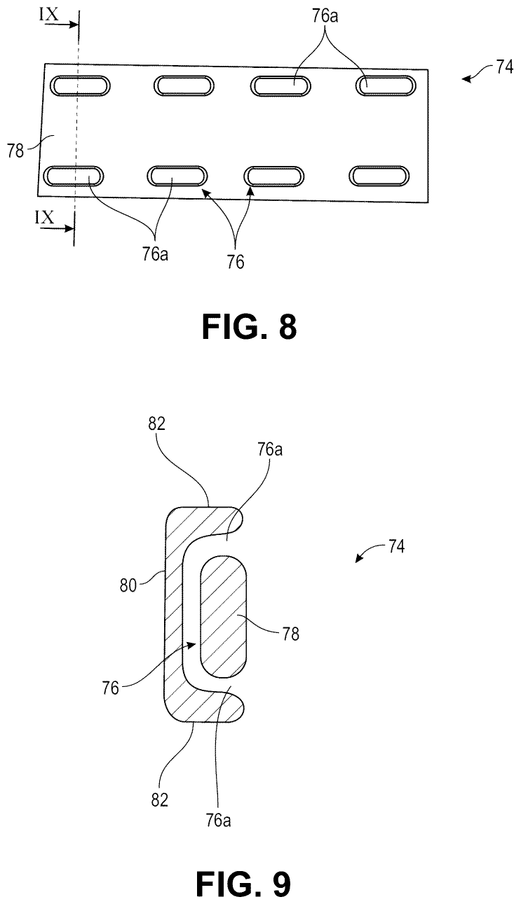

This method comprises a first step of manufacturing one or more foundry cores. In the present example, the vane comprising a blade provided with at least one cavity for circulating cooling air is made from a foundry core, an embodiment of which is shown in FIGS. 8 and 9.

A foundry core is typically obtained by ceramic injection (ceramic which is then debinded and sintered). However, the core used in this invention cannot be produced by the injection because it cannot be easily demoulded.

On the other hand, this core can be obtained by additive manufacturing of ceramic or any other suitable material such as refractory metals.

In the case of FIGS. 8 and 9, the ceramic core 74 is elongated and comprises internal U-shaped ducts 76 which are configured to form the projecting elements, i.e., the arches 50, by moulding. Each of these ducts 76 comprises two ends 76a which open onto the same face 78 of the core configured to form the aforementioned first wall 56 by moulding. The core 74 comprises a face 80 opposite the face 78 and configured to form the aforementioned wall 60 by moulding. The lateral faces 82 of the core 74 are configured to form the aforementioned lateral walls 72 by moulding.

In another step of the method, wax or an equivalent material is injected around the core 70 or an assembly of cores, which are advantageously, but not exclusively, placed in a press beforehand. Once the wax has cooled, we obtain a model comprising the cores embedded in the wax.

The model is arranged on a column with other similar models to form a cluster.

The method also involves creating a shell of refractory material around the cluster, which acts as a mould. In this example, the refractory material is ceramic. The shell is made by immersing the bunch several times in a ceramic slip.

In another step of the method, molten metal is poured or cast into the shell to fill the cavities obtained when the wax is removed from the models and intended to form the metal parts, in this case the turbine vanes. In fact, prior to this step of pouring the metal, a step of removing the wax is carried out.

Once the shell has cooled and solidified, a stripping step allows the shell and cores in the metal parts (vane) to be destroyed, revealing the final vane and the cooling fluid circulation cavities.

The present invention provides several advantages, including:
an improvement in the heat exchange/pressure loss ratio in the cooling cavity of the vane,
an improvement in the volume ratio of the projecting element and therefore of the arch (and therefore of the mass of the vane) to the exchange surface,
a better control of the trading improvement area and more uniform trading within this area,
a potential reduction in the number of projecting elements (and therefore the mass of the vane) to cool critical areas,
cooling of the opposite wall, if necessary, by modifying the shape of the projecting element (in particular the slope of the external face of its roof to increase or reduce the intensity of the vortices released at the corners of the arch),
etc.

1. A vane for an aircraft turbomachine, the vane comprising a blade and a cooling circuit inside the blade, the cooling circuit comprising at least one longitudinal cavity configured for the flow of a cooling air stream (RF), the cooling circuit further comprising projecting elements located in said cavity and configured to disrupt said air stream, wherein each of said projecting elements has a shape of an arch and comprises two lateral legs and a median roof, the legs extending between a first wall of the cavity and said roof, the roof interconnecting said legs, each of said elements defining internally, with said first wall, a first passage cross-section, and externally, with a second wall opposite the first wall, a second passage cross-section, each of said elements being configured so that said first or second passage cross-section is reduced from upstream to downstream with respect to a direction of said air stream.

2. The vane according to claim 1, wherein the roof comprises a first face which faces the first wall, and a second face which faces the second wall, at least one of the first and second faces being inclined relative to the first and second wall, respectively, from upstream to downstream relative to the direction of said air stream, so as to reduce the corresponding passage cross-section.

3. The vane according to claim 2, wherein said first and second faces are parallel to each other.

4. The vane according to claim 1, wherein said roof of each of said projecting elements is inclined with respect to said first and second walls.

5. The vane according to claim 1, wherein said projecting elements are arranged one behind the other inside said cavity and form a row of projecting elements extending along said direction of said air stream.

6. The vane according to claim 1, wherein said legs of each of said projecting elements are separated from each other by a distance representing more than 40% of a width of said cavity.

7. The vane according to claim 1, wherein said legs of each of said projecting elements are oriented in a convergent manner from upstream to downstream.

8. The vane according to claim 1, wherein said legs and said roof of each of said projecting elements comprise upstream edges which are convexly rounded.

9. The vane according to claim 1, wherein said roof of each of said projecting elements is located at half a height in said cavity, the height being measured between said first and second walls.

10. The vane according to claim 1, wherein each of said projecting elements defines an internal air passage cross-section which has a generally rectangular, circular, oblong or trapezoidal shape.

11. The vane according to claim 1, wherein a reduction in the passage cross-section from the inlet to the outlet of each of the projecting elements is of the order of at least 10%.

12. The vane according to claim 1, wherein the passage cross-section inside and at the inlet of each of the projecting elements represent at least 25% of the total passage cross-section of the cavity.

13. The vane according to claim 1, wherein each of the projecting elements has a length noted L3 and has an inlet with a height noted h, the length L3 being between 0.5.h and 3.h.

14. A turbomachine turbine comprising the vane according to claim 1.

15. A method for lost-wax manufacturing of the vane according to claim 1, the method comprising the steps of:
providing a refractory ceramic or metallic core for forming said cavity, the core having an elongate shape and comprising internal U-shaped ducts which are configured to form said projecting elements by molding, each of said ducts comprising two ends which open onto a same face of the core configured to form said first wall by molding,
injecting wax so as to coat the core and form a model,
manufacturing a shell enveloping the model,
pouring molten metal into the shell to form the vane, and
stripping the shell and core so as to release the vane and form the cooling circuit with the cavity and projecting elements.

16. The vane according to claim 5, wherein the row comprises between 5 and 10 projecting elements.
